(19) United States
(12) Patent Application Publication
(10) Pub. No.: US 2026/0243384 A1
(43) Pub. Date: Aug. 20, 2026

(54) COUPLING FOR CRYOGENIC CONDUITS

(71) Applicant: Witzenmann GmbH, Pforzheim (DE)

(72) Inventors: David EHRENBERGER, Königsbach-Stein (DE); Alexander LEIPPI, Pforzheim (DE)

(73) Assignee: Witzenmann GmbH, Pforzheim (DE)

(21) Appl. No.: 19/414,410

(22) Filed: Dec. 10, 2025

(30) Foreign Application Priority Data
Dec. 10, 2024 (DE) 102024136996.5

(51) Int. Cl. F16L 59/065; F16L 59/14; F16L 59/18

(52) U.S. Cl. CPC F16L 59/065; F16L 59/141; F16L 59/182

(57) ABSTRACT

A coupling for cryogenic lines having a coupling socket and coupling plug which has a first inner, pipeline element and a first outer pipeline element which surrounds it coaxially, with an evacuable first free space therebetween. The coupling socket has a second inner pipeline element and a second outer pipeline element which surrounds it coaxially, with an evacuable second free space therebetween. The inner pipeline elements are detachably connected. The outer pipeline elements are detachably connected. A drive element is connected to the coupling plug and has an engagement structure complementary to a second engagement structure on the coupling socket or coupling plug. After the first and second engagement structures are engaged, a rotation of the drive element effects an axial relative movement of the coupling plug and the coupling socket, creating a fluid-tight connection between the first and second inner pipeline elements.

### TECHNICAL FIELD

The invention relates to a coupling for cryogenic lines (lines for transporting cryogenic media such as liquid helium or hydrogen).

### BACKGROUND

Such a coupling can be designed in particular as a plug coupling for cryogenic lines and regularly comprises a coupling socket and a coupling plug, wherein the coupling socket and the coupling plug each have an inner pipe element and an outer pipe element arranged coaxially to the inner pipe element. In a connected state, the coupling plug is inserted into the coupling socket. Furthermore, in the connected state, the coupling socket and the coupling plug are detachably connected to each other by a first connection located at one end, referred to as the “hot” end, in the area of their outer pipe elements. Furthermore, in the connected state, a joint gap between the coupling socket and the coupling plug in the area of their inner pipe elements is sealed by a gasket at another end designated as the “cold” end. The coupling socket and coupling plug are usually made of metal, preferably (stainless) steel.

Such couplings are also known as Johnston couplings. Examples are known from DE 41 07 652 A1 or EP 3 339 713 B1. Sealing against the system pressure takes place in the so-called warm part of the coupling.

Due to the warm seal, both so-called insulation pipes, i.e., the inner pipe element of the coupling socket and the outer pipe element of the coupling plug, are subjected to (usually atmospheric) ambient pressure. In particular, the insulation pipe of the coupling plug (hereinafter also referred to as the “plug”) is at risk of buckling, which is why the aforementioned component had to be designed with a robust thick wall in accordance with the prior art. Among other things, this has the disadvantage of increased heat input at the cold end of the coupling.

Furthermore, a gap formed between the outer pipe element of the plug and the inner pipe element of the coupling socket (hereinafter also referred to as the “socket”) is regularly partially filled with cold liquid (the cryogenic medium) due to insufficient sealing at the cold end, and there is a risk that a thermally insulating gas cushion between a sealing element present at the hot end and this liquid will be overcome by the liquid, resulting in the sealing element being cooled. As a result, the sealing element becomes brittle and the function of the seal is no longer guaranteed.

This circumstance means that such couplings must preferably be positioned in such a way that a normal vector of the coupling separation plane has a positive component parallel to the gravitational vector. In other words, the couplings cannot be installed completely horizontally, which accordingly impairs their possible applications.

DE 10 2022 110 880 A1 discloses another connection arrangement or coupling for a cryogenic line with an inner line element and an outer line element, in which a spacer element, which is arranged between an inner connection element and an outer connection element and seals a free space between the two line elements against the environment, is designed as a grooved membrane disk and is arranged in a plane that extends transversely to a longitudinal axis of the pipe. This results in a relatively short axial extension, yet still provides a sufficiently long path for the incident heat to thermally insulate the connection well. However, the problem described above for Johnston couplings due to insufficient sealing at the cold end can also arise here.

### SUMMARY

The object of the invention is that of developing a coupling of the type mentioned in such a way that improved sealing is achieved at the cold end. This is intended to reduce the risk of cooling for the “warm” sealing element and the heat input at the cold end of the coupling.

This object is achieved in accordance with the invention by a coupling having one or more of the features disclosed herein. Advantageous embodiments are defined in the description and claims that follow.

A coupling for cryogenic lines according to the invention, with a coupling socket and a coupling plug, initially provides that the coupling plug has a first inner, media-carrying pipeline element and a first outer pipeline element, which surrounds the first inner pipeline element coaxially at a radial distance. An evacuable first free space is formed between these two first pipeline elements. The coupling socket has a second inner pipeline element and a second outer pipeline element which surrounds the second inner pipeline element coaxially at a radial distance. An evacuable second free space is formed between these two second pipeline elements. The first inner pipeline element is detachably connected or connectable to the second inner pipeline element. The first outer pipeline element is detachably connected or connectable to the second outer pipeline element.

This previously known arrangement is now characterized in accordance with the invention by an additional drive element which is connected or connectable to the coupling plug and which has a first engagement structure that is complementary to a second engagement structure on the coupling socket, or vice versa. The invention also provides that, after the first engagement structure and the second engagement structure have been engaged, a rotational movement of the coupling plug and coupling socket about a common longitudinal axis of the pipeline elements (i.e., a corresponding torque) is or can be effected by a rotational movement exerted on the drive element from the outside. This creates or enables a secure and defined fluid-tight connection between the first inner pipeline element and the second inner pipeline element at the cold end.

According to the invention, it is therefore proposed to use an additional drive element to cause a relative axial movement of the inner pipeline elements in order to form the connection at the cold end in a process-reliable manner by means of a targeted and definable rotational effect (i.e., a torque) from outside on the drive element and to prevent the escape of process fluid (i.e., cryogenic medium) and the associated problems.

In this context, the present invention proposes two basic embodiments or variants, which will be discussed in more detail below.

In both variants, a development of the coupling according to the invention provides for a sealing chamber with defined dimensions, at least in the axial direction, to be formed in the connection area between the first inner pipeline element and the second inner pipeline element, in which a seal is accommodated.

By providing such a sealing chamber with defined dimensions at least in the axial direction, improved sealing against the process medium escaping into an area between the pipelines can be achieved reliably and reproducibly.

In both variants, a development of the coupling according to the invention provides that the sealing chamber is formed by the two inner pipeline elements being arranged in a block. This does not have to be done directly, but can be done with the interposition of further (pipeline) elements.

By arranging the two inner pipeline elements in a block, the sealing effect can be adjusted precisely, reliably, and reproducibly: as soon as the torque required to tighten the connection increases significantly, the two inner pipeline elements rest against each other in a block, and the intended seal is achieved.

In both variants, a development of the coupling according to the invention provides that the sealing chamber is formed between an end closure element of the coupling plug and an end closure element of the coupling socket, preferably as a circumferential recess in the end closure element of the coupling socket or the coupling plug.

These closure elements are regularly formed in the form of turned parts, so that the recesses required to create the sealing chamber can be produced easily and reliably, wherein the sealing chamber also has the required stability.

In both variants, a development of the coupling according to the invention provides that an axial dimension of the sealing chamber is limited by an axial oversize of an axial projection of the end closure element of the coupling plug beyond the remaining end closure element of the coupling plug or by an axial oversize of an axial projection of the end closure element of the coupling socket beyond the remaining end closure element of the coupling socket. The aforementioned closure elements serve in particular to connect the inner, media-carrying pipeline elements.

The aforementioned excess or projection allows the mechanical contact between the two inner pipe elements (“in a block”) mentioned above to be established reliably and reproducibly without affecting more sensitive components of the arrangement (e.g., sealing elements).

In both variants, a development of the coupling according to the invention provides that the drive element is designed to be torsion-resistant, in particular by using a grooved membrane disk or as an additional pipeline element, which is preferably designed at least in sections as a corrugated hose, in particular as a ring corrugated hose, most preferably as a bellows, and which does not need to be fluid-tight.

This enables the transmission of a rotational movement exerted on the drive element from the outside about a common longitudinal axis of the pipeline elements and can at the same time ensure good thermal decoupling of the hot end and cold end by increasing the thermal resistance.

Specifically in a first variant of the coupling according to the invention, it is further provided that the engagement structures are designed as complementary thread structures, preferably as internal threads on the drive element and as external threads on the coupling socket, most preferably on the second inner pipeline element, or vice versa.

In this way, the intended rotational movement exerted on the drive element from the outside around a common longitudinal axis of the pipeline elements can be converted safely and definitively into the desired relative movement in the axial direction.

Specifically in the first variant of the coupling according to the invention, it is further provided that, after the first engagement structure and the second engagement structure have been brought into engagement, there is an axial overlap region in which a screw connection is formed between the drive element and the coupling socket. The coupling plug engages axially between the drive element and the second inner pipeline element with a radial drive projection in the overlap area, so that the coupling plug is moved or can be moved axially in the direction of the second inner pipeline element (i.e., in the direction of the coupling socket) when the screw connection is tightened.

This represents a preferred embodiment for effecting the desired relative movement in the axial direction. The plug, socket, and drive element are fundamentally designed or arranged to be torsion-free relative to each other.

In the first variant of the coupling according to the invention in particular, it is further provided that the drive projection is designed as a retaining ring or snap ring, which is partially arranged in a circumferential groove on the coupling plug.

Such an embodiment is particularly simple and inexpensive to manufacture, which has a favorable effect on the overall manufacturing costs of the coupling.

Specifically in the first variant of the coupling according to the invention, it is further provided that the drive element extends axially from a “hot end,” at which the first outer pipeline element and the second outer pipeline element are connected to each other, to a “cold end,” where the first inner pipeline element and the second inner pipeline element are connected to each other, the drive element being preferably arranged radially between the coupling socket and the coupling plug. In the first variant, the “hot end” and the “cold end” are not usually located at a common axial position.

The drive element does not have to be fluid-tight, but may have holes, openings, or the like, as long as it remains torsion-stable. This saves material and weight, and heat conduction can be reduced, which can bring corresponding advantages.

In this way, a kind of “remote control” of the connection can be achieved, whereby external influences in the area of the easily accessible hot end can be used to achieve a targeted seal at the (difficult or impossible to access) cold end.

Specifically in the first variant of the coupling according to the invention, it is further provided that the first outer pipe element is designed as a structured pipe element at least in a partial section and has an outer contour in that partial section that deviates from a smooth cylindrical shape. Preferably, the first outer pipe element may have a number of annular bulges in the section, or the first outer pipe element may have a number of distinct local bulges in the section, or the first outer pipe element may have a honeycomb-shaped design of its outer contour in the section.

Accordingly, in the course of the aforementioned development of the first variant, it is proposed that the insulation pipe (i.e., the outer pipe element) of the plug (i.e., the first outer pipeline element) of a Johnston coupling be structured i.e., with an outer contour that deviates from a smooth cylindrical shape, in order to counteract bulging and thus enable the insulation pipe to be made thinner-walled than in the prior art. This limits heat conduction and reduces heat input. In addition, the structuring also helps to stabilize the gas cushion locally, so that media impact on the warm sealing element can be efficiently prevented.

In particular, the embodiment of the aforementioned insulation pipe as a so-called “bulged pipe” with wave-shaped bulges is advantageous here, as the wave-shaped cross-section of the structuring significantly increases the resistance to bulging.

Alternatively or additionally, the drive element can also be designed as a structured pipe element (preferably as a so-called “bulged pipe”) in at least one section. The advantage of the “bulged pipe” or other types of structured pipe elements is increased resistance to buckling, and they also perform a guiding function when the coupling is assembled. Since, in the context of the present invention, the insulation pipe of the plug is not subjected to pressure because the seal at the cold end seals effectively, the aforementioned guiding function can also be performed by the drive element in particular. The advantages of a structured insulation pipe mentioned below therefore also apply mutatis mutandis—with appropriate design—to the drive element.

In addition, this allows a large joint gap to the insulation pipe (the inner pipe element) of the socket (i.e., the second inner pipeline element) or to the drive element to be reduced locally. With the appropriate design, this creates circumferential chambers between the two insulation pipes or between the insulation pipe of the plug and the drive element of the connected coupling, which are separated from each other only by narrow annular gaps. The annular gaps can be made so small that liquid process medium is forced to change phase in the gap area due to the heat input via the insulation pipes and the drive element, thereby forming a localized or even several localized gas cushions, which allows the coupling to be positioned independently of the direction of gravity.

An additional advantage is that the wave crests of the “bulged pipe” act as a guide during coupling and effectively reduce friction between the plug and the drive element.

The required roundness of the pipe elements (insulation pipes) and the drive element can be achieved by manufacturing them by means of forming (calibration), e.g., by internal high-pressure forming or, most preferably, by bellows pressing.

The following embodiments have proven to be particularly advantageous in this context (i.e., in the first variant):

One embodiment of the coupling according to the invention provides that the outer pipe element of the coupling plug (i.e., the first outer pipeline element) has a number of annular bulges in the section. Preferably, this number is a plurality of bulges. This allows several of the above-mentioned narrow ring gaps to be created, which greatly improves the insulating effect.

One embodiment of the coupling according to the invention provides that the bulges are identical in shape. This contributes to a further improved insulating effect and allows the advantageous use of a smooth pipe as an outer insulation pipe or as a drive element.

One embodiment of the coupling according to the invention provides that the bulges have an axially symmetrical design in a section along a longitudinal axis of the coupling with respect to an axis perpendicular to the longitudinal axis through a vertex of a respective bulge. This has proven to be particularly advantageous for stability reasons.

One embodiment of the coupling according to the invention provides that the bulges have a continuously curved course in the direction of the inner pipe element of the coupling plug (i.e., the second inner pipeline element) or in the direction of the drive element. This also contributes to further stabilization and is additionally advantageous with regard to the aforementioned reduction in friction.

Another embodiment of the coupling according to the invention provides that the outer pipe element of the coupling plug has a number of distinct local bulges in the section, which are preferably not formed continuously around the circumference. In a specific design, this results in a so-called “dimpled pipe,” i.e., a pipe element with a dimple structure similar to a golf ball. Such an embodiment is also advantageous for stability reasons, which enables lower material usage and reduced heat conduction.

Yet another embodiment of the coupling according to the invention also provides for the local bulges to be arranged in a regular pattern. According to the applicant's findings, this has proven to be advantageous because it increases stability evenly. The joining properties are also improved accordingly.

Yet another embodiment of the coupling according to the invention provides that the outer pipe element of the coupling plug has a honeycomb-shaped design of its outer contour in the section. Such a structure is also advantageous for stability reasons.

In a development of this embodiment of the coupling according to the invention, the honeycomb-shaped design may have hexagonal bulges and recesses bounded by these bulges, or vice versa. This achieves advantages comparable to those of the above-mentioned ring-shaped wave structures.

In another embodiment of the coupling according to the invention, the outer pipe element of the coupling plug is provided to bear against the inside of the drive element, in particular with its bulges according to one of the embodiments described above. This makes it possible to form the aforementioned separate areas or circumferential chambers, between which thermally insulating gas cushions can form, further improving the efficiency of the coupling.

In another embodiment of the coupling according to the invention, it is also provided that the outer pipe element of the coupling plug is axially preloaded, in particular during the actual coupling process, in order to specifically form the bulges radially outward and to close gaps, in particular annular gaps, between the outer pipe element of the coupling plug and the drive element, or at least to make them as narrow as possible. The advantages associated with this have already been mentioned above.

In another embodiment of the coupling according to the invention, it is further provided that a local sealing element insert is arranged between the outer pipe element of the coupling plug and the drive element at least in the area of a sub-number of the bulges, preferably at all bulges. This further improves the closing of the (ring) gaps.

In a development of this embodiment of the coupling according to the invention, it is also provided that the sealing element insert consists of a metal, preferably indium. Metal seals are generally highly vacuum-resistant and resilient. The choice of indium in particular can ensure that no additional increased heat conduction occurs, as would be the case, for example, with the use of copper.

In another embodiment of the coupling according to the invention, it is also provided that at least the outer pipe element of the coupling plug is a cost-effective longitudinally welded tube, which has been modified preferably by forming, such as preferably internal high-pressure forming or most preferably by bellows pressing. These methods are known to those skilled in the art. This achieves improved roundness and, at the same time, improved sealing, as already mentioned.

In another embodiment of the coupling according to the invention, it is also provided that at least the outer pipe element of the coupling plug has a variable wall thickness in the axial and/or circumferential direction.

The term “variable wall thickness” means that the wall thickness is not constant, but assumes different values in the axial direction (along the longitudinal axis) and/or in the circumferential direction. On the one hand, this circumstance can be specifically exploited during forming. In addition, the applicant has found that such a change in wall thickness also increases the stability of the insulation pipe and leads to reduced material usage (with lower heat conduction).

In yet another embodiment of the coupling according to the invention, the outer pipe element of the coupling plug is stabilized by additional elements, such as stabilizing rings, which are preferably fixed in a form-fitting manner, most preferably in an integrally bonded manner. These additional elements are preferably arranged at selected positions along the outer pipe element of the coupling plug. They can help to specifically influence or mitigate its buckling behavior. In the warm range, they are preferably made of plastic, preferably fiber-reinforced, most preferably G10, and in the cold range, they are made of steel, preferably austenitic steel, which can be bonded/fixed in an integrally bonded manner. However, in order to achieve the advantage of using identical parts, the embodiment can also be limited to only one (identical) type.

In this way, the present invention achieves the following further advantages over the prior art, especially in the context of the first variant: lightweight construction with reduced material usage, increased robustness against buckling, enabling position-independent installation, and reduction of heat input. Due to the improved thermal decoupling, a shorter overall length than the prior art can also be achieved.

Another development of the coupling according to the invention in the first variant provides that the section in which the first outer pipeline element is structured coincides axially with a section of the drive element in which the drive element is designed as a smooth pipe, and vice versa.

In this way, the first outer pipeline element and the drive element complement each other geometrically, which can contribute to a reduced overall size.

Another development of the coupling according to the invention of the first variant provides that the drive element has a radially protruding part accessible from the outside, preferably with a regular hexagonal shape.

In this way, the required rotational effect can be achieved as easily as possible and with standard tools.

Another development of the coupling according to the invention of the first variant provides that the drive element is connected or connectable to the coupling plug via the radial projection, preferably by means of a first clamp.

This is a simple and well-proven connection option that can be implemented without significant (cost) expenditure.

Another development of the coupling according to the invention of the first variant provides that the drive element has an outer threaded portion.

This threaded portion allows further components of the coupling to be attached, as will be discussed below.

Another development of the coupling according to the invention in the first variant provides for a screw-on part to be screwed onto or screwable onto the threaded portion, in particular in the manner of a lock nut, preferably up to the coupling socket (as a pressure stop).

This provides a simple means of fixing the coupling socket and screw-on part (and, via this, also the coupling plug) axially relative to each other and compensating for tolerances.

Another development of the coupling according to the invention of the first variant provides that the drive element is connected or connectable to the coupling socket via the screw-on part, preferably by means of a second clamp, and acts as a tension anchor.

This in turn represents a simple and well-proven connection option that can be implemented without major (cost) expenditure.

Certain advantageous developments of the second variant of the coupling according to the invention already mentioned, which is based on the solution known from DE 10 2022 110 880 A1, are now described in more detail below:

A development of the coupling according to the invention of the second variant provides that the drive element has a first, ring-shaped outer connecting part and a second, ring-shaped inner connecting part, which are arranged concentrically and together form the first engagement structure and are connected in a torsion-resistant manner by means of a radially extending first grooved membrane disk. The first grooved membrane disk can be fixed to the two connecting parts, in particular in an integrally bonded manner.

The term “torsion-resistant” means here and in the following that torques can be transmitted by means of the relevant connection (or a correspondingly designed component, e.g., the aforementioned grooved membrane disk).

On the one hand, the grooved membrane disk ensures effective thermal decoupling of the two connecting parts without requiring a larger installation space in the axial direction. The concentric connecting parts can contribute to achieving a particularly good and secure connection. In addition, the grooved membrane disk enables the transmission of torque, which will be discussed in more detail shortly.

In the second variant, the “hot end” and “cold end” are regularly located at least approximately at a common axial position.

A development of the coupling according to the invention in the second variant provides that the coupling socket on the second outer pipeline element has first connection structures and on the second inner pipeline element has second connection structures, which together form the second engagement structure.

In this way, a particularly good and secure connection can be created together with the above-mentioned concentric connecting parts.

A development of the coupling according to the invention in the second variant provides that the first engagement structure and the second engagement structure are designed in the manner of a bayonet lock and interact accordingly. Preferably, the first connecting structures can interact with the first connecting part and the second connecting structures with the second connecting part.

Bayonet locks are known to those skilled in the art. In the present context, the bayonet lock advantageously ensures that the intended axial movement can be achieved with only a small amount of rotational movement (i.e., limited in the circumferential direction).

A development of the coupling of the second variant according to the invention provides that the coupling socket has a radially extending second grooved membrane disk which connects the second outer pipeline element and the second inner pipeline element and which is arranged in a form-fitting manner to the first grooved membrane disk.

In this context, the term “form-fitting” means that the first grooved membrane disk and the second grooved membrane disk lie congruently on top of each other (i.e., their wave crests and troughs can interlock) when the coupling is closed.

The second grooved membrane disk may be specially designed to seal a radial clearance between the second outer pipeline element and the second inner pipeline element in the area of the coupling socket from the environment, thus making it evacuable, which can improve thermal insulation.

A development of the coupling according to the invention of the second variant provides that the second grooved membrane disk is axially supported at the rear.

This can increase resistance to ambient pressure after evacuation. The term “rear” refers to the side facing away from the coupling point.

A development of the coupling according to the invention in the second variant provides that the first grooved membrane disk and the second grooved membrane disk have different dimensions in the radial direction.

This can allow for different (radial) dimensions of the pipeline elements or connecting parts in the area of the plug and socket.

A development of the coupling according to the invention in the second variant provides that the coupling plug has a radially extending third grooved membrane disk which connects the first outer pipeline element and the first inner pipeline element and which is arranged in a form-fitting manner to the first grooved membrane disk and the second grooved membrane disk.

In this context, the term “form-fitting” again means that the first grooved membrane disk, the second grooved membrane disk, and the third grooved membrane disk lie congruently on top of each other (i.e., their wave crests and troughs can interlock), especially when the coupling is closed.

The third grooved membrane disk may be specifically designed to seal a radial gap between the first outer pipeline element and the first inner pipeline element in the area of the coupling plug from the environment, thus making it evacuable, which can improve thermal insulation.

A development of the coupling according to the invention of the second variant provides that the third grooved membrane disk is axially supported at the rear. The term “rear” again refers to the side facing away from the coupling point.

This increases resistance to ambient pressure after evacuation.

A development of the coupling according to the invention in the second variant provides that the first grooved membrane disk and the third grooved membrane disk have the same dimensions in the radial direction.

This ensures improved stability and is thus possible because both grooved membrane disks are located on the same component (the plug).

In the assembled state of the coupling, the first grooved membrane disk is preferably arranged between the second and third grooved membrane disks, wherein the latter two are axially supported from the outside.

### BRIEF DESCRIPTION OF THE DRAWINGS

Further features and advantages of the invention can be found in the following description of embodiments with reference to the drawing.

FIG. 1 shows a coupling according to the invention in accordance with the first variant in its individual parts;

FIGS. 2A-2C show the key components of the coupling from FIG. 1 in longitudinal section;

FIG. 3 shows the coupling from FIG. 1 in longitudinal section and in assembled state;

FIG. 4 shows a coupling according to the second variant of the invention in longitudinal section and in an open state;

FIG. 5 shows the coupling from FIG. 4 in its closed state;

FIG. 6 shows a detailed view of the coupling socket according to the embodiment in FIG. 4;

FIG. 7 shows a detailed view of the coupling plug according to the embodiment in FIG. 4;

FIG. 8 shows a sectional view of a coupling according to the invention in another embodiment.

### DETAILED DESCRIPTION

In all figures, identical reference signs denote identical or at least identically functioning elements. The terms “pipe element” and “pipeline element” are used synonymously throughout.

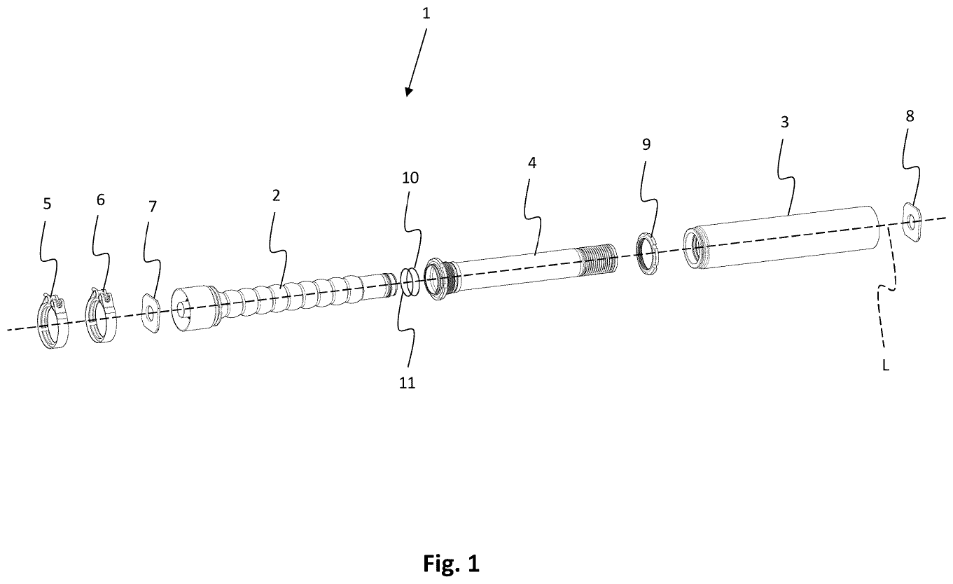

FIG. 1 shows an exploded view of the individual parts of a coupling 1 according to the invention of the first variant with longitudinal axis L. Reference sign 2 denotes the coupling plug (plug), and reference sign 3 denotes the coupling socket (socket). A tubular drive element 4 is arranged between them, which is also designated by reference sign 36 below. The coupling 1 also comprises two clamps 5, 6, two centering elements 7, 8, a screw-on part 9, and two seals (sealing rings) 10, 11. All of these elements and their interaction will be discussed in more detail below.

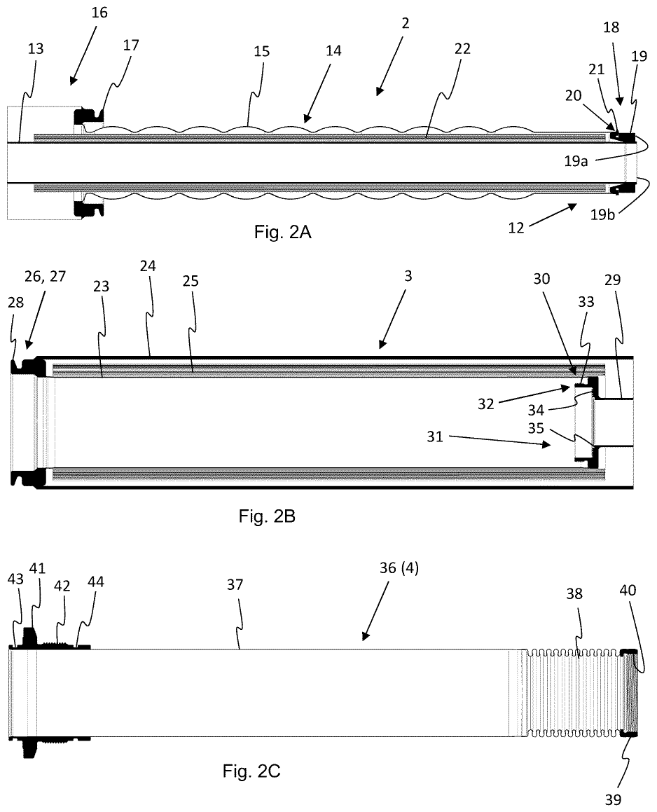

According to FIG. 2A, the plug 2 comprises two coaxial pipe elements starting from its front insertion end 12, namely an inner (media-carrying) pipe element 13 and an outer pipe element 14. The outer pipe element 14 is partly designed as a structured pipe element and accordingly has an outer contour that deviates from a smooth cylindrical shape over most of its length. Specifically, over most of its length, it is structured as a “bulbed pipe” with several identical ring-shaped bulges 15, only one of which is explicitly designated. This allows the pipe element 14 to be made lighter and thinner while maintaining the same or even improved (pressure) stability. The outer pipe element 14 of the coupling plug 2 is preferably manufactured by forming, such as preferably internal high-pressure forming or most preferably bellows pressing.

At one end 16 (the so-called “hot end”), the outer pipe element 14 is radially expanded and has no bulges in this area. In a transition area between the bulges 15 and the expanded end 16, an approximately triangular elevation 17 is provided on the outside, which will be discussed in more detail later.

At the other end 18 (the so-called “cold end”), a first closure element 19 is arranged, which connects the inner pipe element 13 and the outer pipe element 14 in a fluid-tight manner, preferably in an integrally bonded manner. The closure element 19 has a front end face 19a with an inner, circumferential projection 19b. A drive projection 21 in the form of a retaining ring is arranged in a circumferential groove 20 of the closure element 19. Reference sign 22 shows a “multi-layer insulation” (MLI), i.e., a multi-layer insulation arranged between the inner pipe element 13 and the outer pipe element 14. The multi-layer insulation is usually in the form of a multi-layer, highly (radiation) reflective foil or the like, which is known to those skilled in the art.

According to FIG. 2B, the socket 3 also comprises two coaxial pipe elements, namely an inner pipe element 23 and an outer pipe element 24, between which a multi-layer insulation (MLI) 25 is arranged. The two coaxial pipe elements 23, 24 of the socket 3 are connected to each other at one end 26 (the “hot end” corresponding to reference sign 16) in a fluid-tight manner via a second closure element 27, preferably in an integrally bonded manner. The second closure element 27 has a shape at reference sign 28 that is mirror-symmetrical to the triangular elevation 17 of the plug 2. The inner pipe element 23 of the socket 3 is tapered at its free end (right in FIG. 2B) and has a fluid-conducting (media-carrying) tube extension 29 connected to the rest of the inner pipe element 23 of the socket 3, the diameter of which is adapted to that of the inner (media-carrying) pipe element 13 of the plug 2. The pipe extension 29 and the inner pipe element 13 of the plug 2 are connected as fluid-tight as possible by means of a seal (not shown in FIGS. 2A-2C), which is described in more detail below.

In a transition area 30 from the inner pipe element 23 to the pipe extension 29, the socket 3 has an annular reduction piece 31, which is preferably formed in an integrally bonded manner with the inner pipe element 23 and in one piece with the pipe extension 29 and which has an axial projection 32 with an external thread 33, a (surface-) structured radial surface 34 and a recess 35 in the transition area between the radial surface 34 and the pipe extension 29.

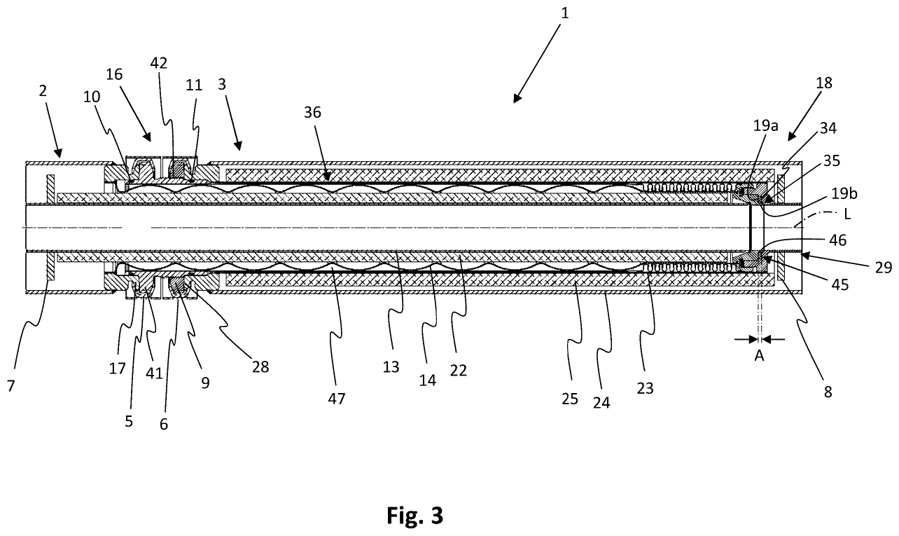

FIG. 2C, shows the additional drive element 36, which was designated with reference sign 4 in FIG. 1 and which is to be arranged radially between plug 2 and socket 3, as will be clearly shown below with reference to FIG. 3. The drive element 36 is tubular in overall design and has a smooth cylindrical section 37 and a corrugated section 38. The smooth cylindrical section 37 corresponds in its longitudinal dimension to the structured section of the pipe element 14, while the corrugated section 38 corresponds in its longitudinal dimension to the smooth cylindrical “remainder” of the pipe element 14. The corrugated section 38 is connected at its end (in an integrally bonded manner) to a ring part 39 with an internal thread 40. At the other end, the drive element 36 has a chamfered radial projection 41 (preferably with an external hexagonal contour), an external thread 42, and two circumferential grooves 43, 44, which serve to accommodate the sealing rings 10, 11 from FIG. 1.

FIG. 3 shows the assembled coupling 1. For clarity, not all elements are labeled again. To connect plug 2 and socket 3 tightly at the cold end 18, the drive element 36 is inserted into the socket 3 and the plug 2 is inserted into the drive element 36. When the drive element 36 is rotated about the longitudinal axis L and screwed onto the external thread 33 (see FIGS. 2A-2C) of the socket 3, which corresponds to feature a) of the invention, it carries the plug 2 along in the axial direction due to the retaining ring 21 (see FIGS. 2A-2C) until the plug 2 strikes with its projection 19b at the end of the recess 35 of the socket 3. In other words, when the drive element 36 reaches the retaining ring 21, a fixed connection in the axial direction is established between the drive element 36 and the plug 2. Then, a sealing chamber 45 with a well-defined (axial) dimension A is formed between the end face 19a of the plug 2 and the radial surface 34 of the socket 3, into which a seal (sealing ring) 46 is inserted, which ensures a secure seal at the cold end 18, while the drive element 36 can be conveniently operated (remotely) from the hot end 16.

To secure the connection at the hot end 16, the plug 2 has the aforementioned, approximately triangular or conical elevation 17 on the outside (see FIGS. 2A-2C), to which the drive element 36 fits snugly with its projection 41 (see FIGS. 2A-2C). Fixation in this area is achieved by means of the clamp 5. Furthermore, the screw-on part 9 is screwed onto the external thread 42 of the drive element 36 in the manner of a lock nut until it abuts against the projection 28 of the socket 3. Here too, fixation is achieved by means of the clamp 6.

In the coupling 1 shown, after the first engagement structure (in particular the internal thread 40 of the drive element 36, see FIGS. 2A-2C) and the second engagement structure (in particular the external thread 33 of the socket 3, see FIGS. 2A-2C), an axial overlap area is formed in which a screw connection is formed between the drive element 36 and the coupling socket 3. The coupling plug 2 engages with its radial drive projection 21 (see FIGS. 2A-2C) in this overlap area axially between the drive element 36 and the second inner pipeline element 23 or the reducer 31, so that the coupling plug 2 can be moved or is moved axially in the direction of the second inner pipeline element 23 or the radial surface 34 of the reducer 31 when the screw connection is tightened.

The clamp (V-brim clamp) 5 is used to connect plug 2 and drive element 4, 36 in a detachable manner, while the clamp 6 (V-brim clamp) is used to connect drive element 4 or 36 and socket 3 in a detachable manner. Reference signs 7 and 8 denote the centering or stabilizing elements mentioned above. These stabilizing elements 7, 8 ensure that the inner pipe element 13 is centered within the outer pipe element 14 in the area of the expanded end of the plug 2 or the tube extension 29 within the outer pipe element 24; they are preferably made of a material with poor thermal conductivity that is vacuum-tight (no outgassing) and preferably consists of a fiber-reinforced plastic, most preferably glass fiber-reinforced plastic, such as G10.

FIG. 3 shows, as already mentioned, the connected state of the coupling 1. In this state, the coupling socket 3 and the coupling plug 2 are detachably connected to each other by a first connection located at the hot end 16 in the area of their outer pipe elements 14 and 24 (by means of the clamps 5, 6 and with the interposition of the drive element 4 or 36). Furthermore, in the connected state, a joint gap between the coupling socket 3 and the coupling plug 2 in the area of their inner pipe elements 13 and 23, 29, respectively, is sealed by the seal 46 at the other, cold end 18.

As can be seen from FIG. 3, the bulges 6 of the pipe element 14 have a symmetrical design in a section along the longitudinal axis L of the coupling 1 with respect to a plane perpendicular to the longitudinal axis L through a vertex (not designated) of a respective bulge 15. In addition, the bulges 15 have a continuously curved, i.e., convex, profile with respect to the longitudinal axis L in the direction of the inner pipe element 13 of the coupling plug 2.

The outer pipe element 14 of the coupling plug 2 rests with its bulges 15 on the inside of the drive element 36 in its smooth cylindrical section. To achieve this, the outer pipe element 14 of the coupling plug 2 can be axially preloaded during the coupling process so that the bulges 15 in particular are formed radially outward in order to close gaps, in particular annular gaps, between the outer pipe element 14 of the coupling plug 2 and the drive element 36. In this way, separate annular cavities 47 are formed along the coupling 1, which ensure that, as far as possible, no cryogenic fluid reaches the “warm” sealing elements 10, 11 and damages them. In any case, any remaining annular gaps between elements 14 and 36 ensure that any cryogenic fluid that has penetrated evaporates and forms gas cushions that act as efficient insulators, thus preventing further heat input from outside.

Although this is not shown in the Figures, at least in the area of a sub-number of the bulges 15, an additional local sealing element insert may be arranged between the outer pipe element 14 of the coupling plug 2 and the drive element 36, which sealing element insert consists in particular of a metal, preferably indium.

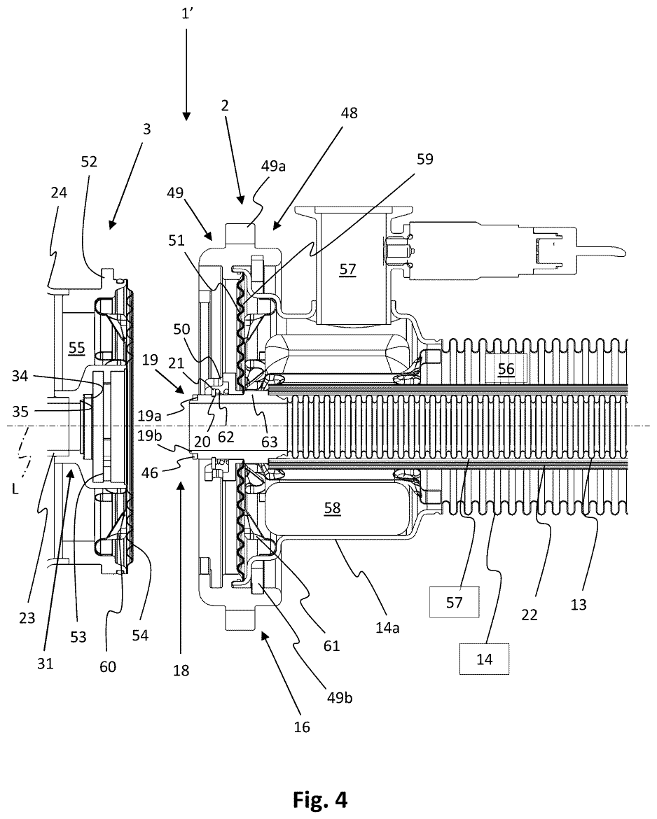

FIGS. 4 to 7 show an alternative embodiment of the coupling 1′, which differs significantly from the variant shown in FIGS. 1 to 3 in the design of the “warm” connection and the drive element.

FIG. 4 shows the coupling 1′ in its open state. In essence, only the most important differences from the first embodiment are discussed in detail.

The coupling 1′ has a drive element 48 in the area of the plug 2, which has a first, ring-shaped outer connecting part 49 with a radial projection 49a, preferably with an outer hexagonal contour, and a second, annular inner connecting part 50, which are arranged concentrically and together form a first, plug-side engagement structure that is specially designed in the manner of a bayonet lock. The connecting parts 49, 50 are connected by means of a radially extending first grooved membrane disk 51. This first grooved membrane disk 51 is fixed to the two connecting parts 49, 50 in an integrally bonded manner. It enables torques to be transmitted from the first connecting part 49 to the second connecting part 50 by means of the drive element 48 and, due to its effective length in the radial direction, ensures a relatively high thermal resistance. The outer connecting part 49 is fastened by means of a retaining ring 49b to a multi-stepped pipe part 14a, which represents an axial extension (connected by an integral bond) of the first outer pipe element 14.

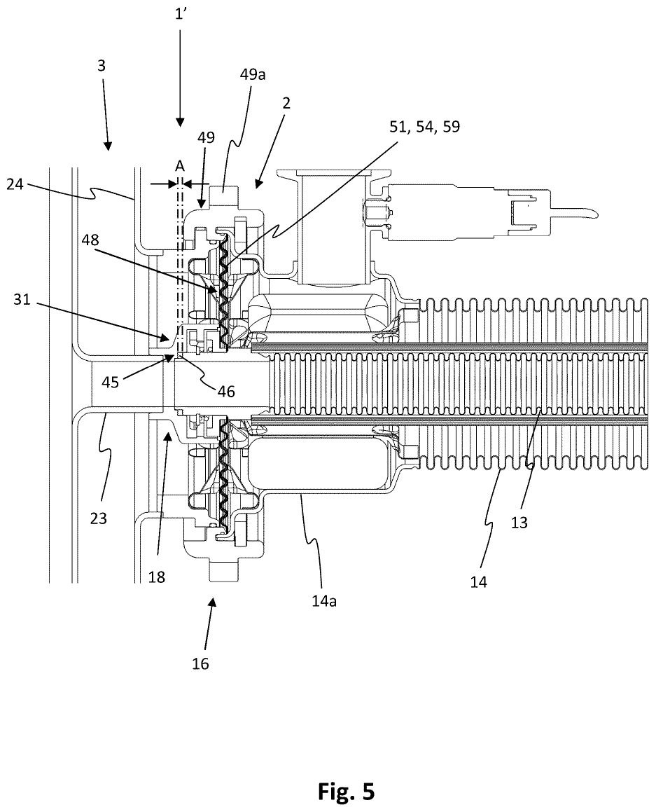

Accordingly, in the coupling 1′ shown in FIG. 4, the coupling socket 3 has first connecting structures 52 on the second outer pipeline element (at reference sign 24, only indicated; see FIG. 5) and second connecting structures 53 on the second inner pipeline element 23, which together form a second, socket-side engagement structure.

As already noted, in this variant, the first plug-side engagement structure and the second socket-side engagement structure are designed in the manner of a bayonet lock and interact accordingly, with the first connecting structures 52 interacting with the first connecting part 49 and the second connecting structures 53 interacting with the second connecting part 50. Bayonet locks are known to those skilled in the art, so that the exact design need not be discussed here. Closing the bayonet lock by means of a corresponding (relative) rotational movement of plug 2 and socket 3 not only ensures that the coupling 1′ is securely locked, but also causes an axial relative movement of plug 2 and socket 3 for sealing purposes, which will be discussed in more detail below.

First, it should be noted that in coupling 1′, coupling socket 3 has a radially extending second grooved membrane disk 54 that connects the second outer pipeline element 24 and the second inner pipeline element 23 via connecting structures 52, 53, so that an intermediate space or clearance 55 between them can be evacuated, and is arranged in a form-fitting manner with respect to the first grooved membrane disk 51, which in this case means that the grooved membrane disks 51 and 54 interlock with their wave troughs and crests when plug 2 and socket 3 are aligned coaxially along the longitudinal axis and brought together axially (see below, FIG. 5).

According to FIG. 4, in the plug 2, the first outer pipe element 14 and also the first inner pipe element 13 are largely designed as a ring corrugated hose. Between them is a gap or free space 56, the MLI 22, and a braided hose 57, which surrounds the inner pipe element 13 in a stabilizing manner. The free space 56 can be evacuated via a connection piece 57. Reference sign 58 denotes an adsorber.

For this purpose, the coupling 1′ or the coupling plug 2 also has a third radially extending grooved membrane disk 59, which connects the first outer pipeline element 14 in the area of the extension pipe part 14a and the first inner pipeline element 13 in the area of the closure element 19 in an integrally bonded manner, so that the intermediate space or free space 56 can be evacuated. The third grooved membrane disk 59 is arranged in a form-fitting manner specifically to the first grooved membrane disk 51 and (when the coupling 1′ is closed, see FIG. 5) also to the second grooved membrane disk 54, as defined above. In FIG. 4, the grooved membrane disks 51 and 59 are already form-fittingly placed on top of each other so that they are no longer recognizable as separate entities.

In order to better resist the ambient pressure when the spaces 55, 56 are evacuated, the second grooved membrane disk 54 and the third grooved membrane disk 59 are each axially supported on the rear side, for which at least one corresponding support element 60, 61 is provided, as shown.

While the first grooved membrane disk 51 and the second grooved membrane disk 54 have different dimensions in the radial direction, the first grooved membrane disk 51 and the third grooved membrane disk 59 preferably have the same dimension in the radial direction, as shown.

The so-called “cold end” 18 is arranged on the inside according to the embodiment in FIG. 4. The aforementioned closure element 19 is also arranged there, which connects the inner pipe element 13 and the outer pipe element 14 together with extension 14a (via the grooved membrane disk 59) in a fluid-tight manner. The closure element 19 in turn has a front end face 19a with an inner, circumferential projection 19b. Reference sign 46 again denotes a seal. A retaining ring 21 is arranged in a circumferential groove 20 of the closure element 19, which, in cooperation with a spring 62 and a circumferential projection 63, ensures that the connecting part 50 is securely held on the closure element 19.

Analogously to the embodiment of the socket 3 according to FIGS. 2A-2C, FIG. 4 also shows a ring part 31 with a radial surface 34 and a recess 35, which, in cooperation with the plug 2, provides a sealing chamber of defined (axial) dimension when the closure element 19 and the ring part 31 come into contact with the projection 19b in the area of the recess 35. This is shown in FIG. 5.

FIG. 5 shows the coupling 1′ from FIG. 4 in its closed state. For reasons of clarity, not all elements are explicitly labeled again (see FIG. 4). The engagement structures interact in a bayonet lock manner, as explained in detail above. All three grooved membrane disks 51, 54, 59 then fit together form-fittingly. The sealing chamber 45 has a defined dimension A in the axial direction, as described above with reference to FIG. 3. Here too, the connection at the cold end 18 is tightened by applying a torque to a drive element 48 at the hot end 16, in this case specifically by acting on element 49 (at reference sign 49a) in order to close the bayonet lock and at the same time cause a relative axial movement specifically of parts 19 and 31, which creates the described seal at the cold end 18.

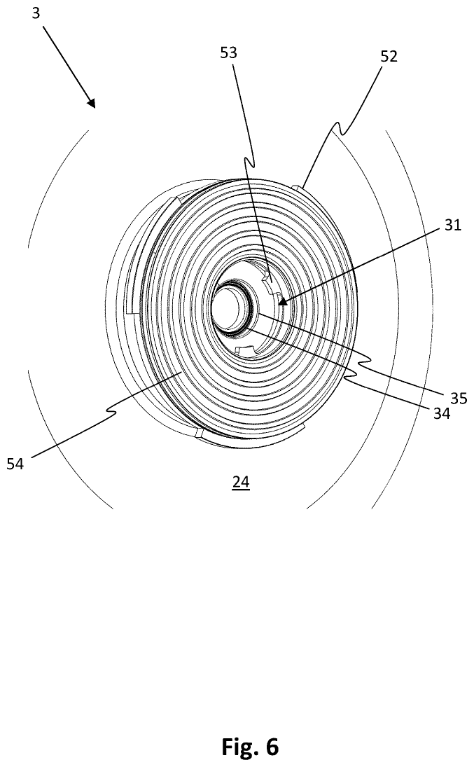

FIG. 6 shows a detailed perspective view of the socket 3 and illustrates the possible embodiment of the bayonet-type connection structures 52, 53 and the embodiment of the corresponding grooved membrane disk 54.

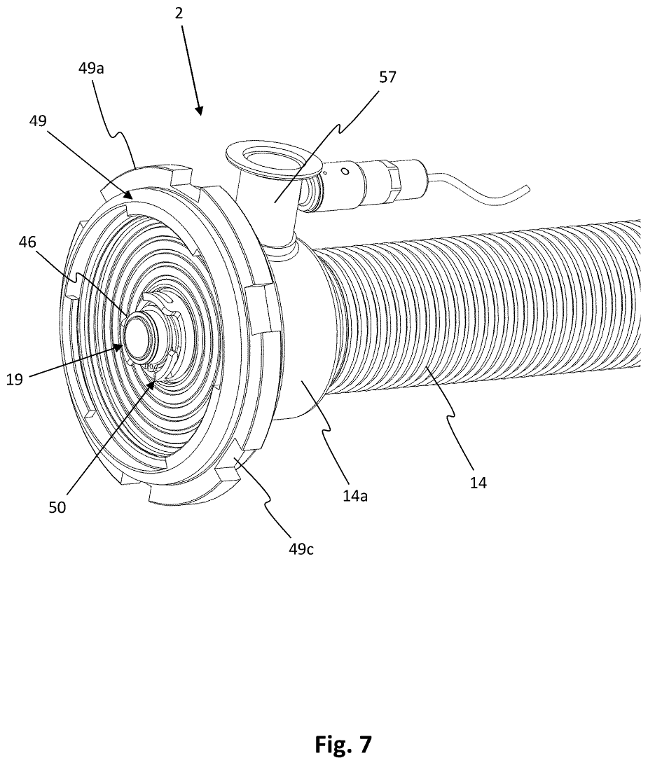

FIG. 7 shows a detailed perspective view of the plug 2 and illustrates the possible embodiment of the complementary bayonet-type connection structures on the connecting parts 49, 50 and the embodiment of the corresponding grooved membrane disk 51, which is used for torque transmission. The torque acts accordingly at reference sign 49a. Element 49 has special recesses 49c for this purpose. Alternatively, an embodiment with a hexagonal contour can also be considered in this area.

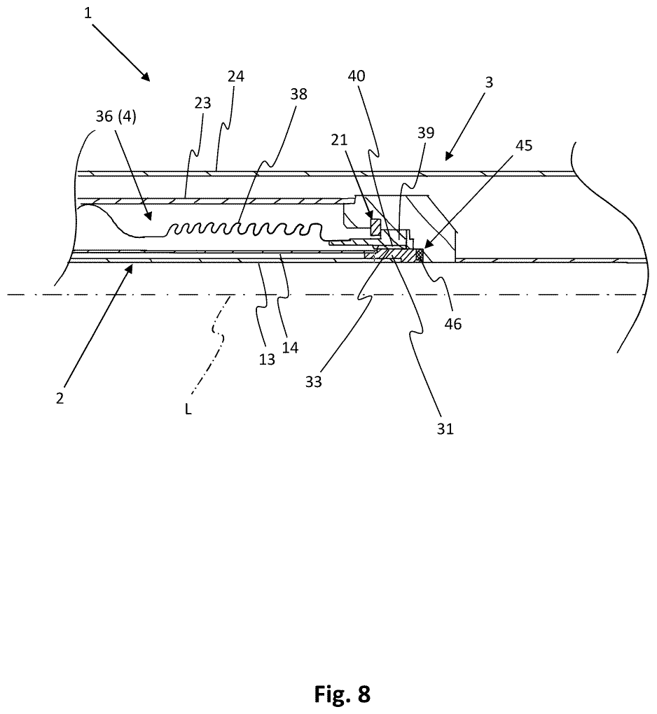

FIG. 8 shows a modification corresponding to feature b) of the invention, which is partially shown in the designs in FIGS. 1 to 3. Here, we will only go into more detail on the main differences to the embodiment already described in FIGS. 1 to 3:

According to FIG. 8, the external thread 40, which forms part of the engagement structure described, is not provided on the socket 3 but on the plug 2. The ring corrugated portion 36 of the drive element 36 is connected at the end (in an integrally bonded manner) to a ring part 39 with an internal thread 40. In contrast, the retaining ring 21 is not located on the plug 2, but between the ring part 39 and the reducing part (closure element) 31 of the socket 3.

In this way, the socket 3 and drive element 36 can be pre-assembled. The described axial relative movement of coupling plug 2 and coupling socket 3 after the first engagement structure and the second engagement structure have been engaged can also be effected here by a rotational movement exerted from the outside on drive element 36 about a common longitudinal axis L of the pipeline elements, whereby a fluid-tight connection is also created or can be created here.

It can also be seen in FIG. 8 that, in contrast to the embodiment in FIGS. 1 to 3, in this case it is not the plug 2 (i.e., specifically the male insulation tube, element 14) that is designed as a bulped pipe, but rather the drive element 36 in a section (to the left of the corrugated portion 38). As already mentioned, a significant advantage of the bulped pipe is its increased resistance to bulging. However, in the present invention, the insulation pipe 14 is not subjected to pressure, as the cold seal 46 provides effective sealing. Therefore, the guide bulps can also be located in the drive element 36. This also applies in principle to the embodiment according to FIGS. 1 to 3.

1. A coupling (1, 1′) for cryogenic lines, the coupling comprising:
a coupling socket (3) and a coupling plug (2);
the coupling plug (2) has a first inner, media-carrying pipeline element (13) and a first outer pipeline element (14) which surrounds the first inner pipeline element (13) coaxially at a radial distance, with an evacuable first free space (56) formed between the first inner, media-carrying pipeline element (13) and the first outer pipeline element (14);
the coupling socket (3) has a second inner pipeline element (23, 29) and a second outer pipeline element (24) which surrounds the second inner pipeline element (23, 29) coaxially at a radial distance, with an evacuable second free space (55) formed between the second inner pipeline element (23, 29) and the second outer pipeline element (24);
the first inner pipeline element (13) is detachably connected or connectable to the second inner pipeline element (23, 29);
the first outer pipeline element (14) is detachably connected or connectable to the second outer pipeline element (24);
a drive element (4, 36; 48) which is connected or connectable to the coupling plug (2) and which has a first engagement structure which is complementary to a second engagement structure on the coupling socket (3) or on the coupling plug (2);
wherein, after the first engagement structure and the second engagement structure have been engaged, a rotational movement exerted on the drive element (4, 36; 48) from outside about a common longitudinal axis (L) of the pipeline elements (13, 14, 23, 24), effects an axial relative movement of the coupling plug (2) and the coupling socket (3) such that a fluid-tight connection is or is adapted be created between the first inner pipeline element (13) and the second inner pipeline element (23, 29).

2. The coupling (1, 1′) as claimed in claim 1, further comprising a sealing chamber (45) with a defined dimension (A) at least in an axial direction is formed in a connection area on a front side between the first inner pipeline element (13) and the second inner pipeline element (23, 29), in which a seal (46) is accommodated.

3. The coupling (1, 1′) as claimed in claim 2, wherein the sealing chamber (45) is formed by the first and second inner pipeline elements (13, 23) being arranged in a block.

4. The coupling (1, 1′) as claimed in claim 2, wherein the sealing chamber (45) is formed between an end closure element (19) of the coupling plug (2) and an end closure element (29, 31) of the coupling socket (3).

5. The coupling (1, 1′) as claimed in claim 4, wherein an axial dimension of the sealing chamber (45) is determined by an axial oversize of an axial projection (19b) of the end closure element (19) of the coupling plug (2) beyond the remaining end closure element (19) of the coupling plug (2) or by an axial excess of an axial projection of the end closure element of the coupling socket (3) beyond the remaining end closure element of the coupling socket (3).

6. The coupling (1) as claimed in claim 1, wherein the drive element (4, 36; 48) is torsion-resistant, by using a grooved membrane disk (51) or as an additional pipeline element (4, 36), which is designed at least in sections as a corrugated hose.

7. The coupling (1) as claimed in claim 1, wherein the first and second engagement structures are complementary thread structures.

8. The coupling (1) as claimed in claim 7, wherein, after the first engagement structure and the second engagement structure have been engaged, there is an axial overlap region in which a screw connection between the drive element (4, 36) and the coupling socket (3) is formed, and the coupling plug (2) engages with a radial drive projection (21) in the overlap region axially between the drive element (4, 36) and the second inner pipeline element (23, 29), so that the coupling plug (2) is movable axially in a direction of the second inner pipeline element (23, 29) when the complementary threaded structures that form a screw connection are tightened.

9. The coupling (1) as claimed in claim 8, wherein the drive projection (21) is a retaining ring or snap ring, which is partially arranged in a circumferential groove (20) on the coupling plug (2).

10. The coupling (1) as claimed in claim 7, wherein the drive element (4, 36) extends axially from a “hot end” (16, 26), at which the first outer pipeline element (14) and the second outer pipeline element (24) are connected to each other, to a “cold end” (18), at which the first inner pipeline element (13) and the second inner pipeline element (23, 29) are connected to each other, and the drive element (4, 36) is arranged radially between the coupling socket (3) and the coupling plug (2).

11. The coupling (1) as claimed in claim 7, wherein the first outer pipe element (14) or the drive element (4, 36) comprises a structured pipe element at least in a section and has an outer contour in the section that deviates from a smooth cylindrical shape.

12. The coupling (1) as claimed in claim 11, wherein the section of the outer pipe element (14) coincides axially with a section of the drive element (4, 36) in which the drive element (4, 36) is a smooth tube (37), or vice versa.

13. The coupling (1) as claimed in claim 7, wherein the drive element (4, 36) has a radially protruding part (41) accessible from the outside, preferably with a regular hexagonal shape.

14. The coupling (1) as claimed in claim 13, wherein the drive element (4, 36) is connected or connectable to the coupling plug (2) via the radial protruding part (41).

15. The coupling (1) as claimed in claim 7, wherein, wherein the drive element (4, 36) has an outer threaded portion (42).

16. The coupling (1) as claimed in claim 15, wherein a screw-on part (9) is screwed or is adapted to be screwed onto the threaded portion (42).

17. The coupling (1) as claimed in claim 16, wherein the drive element (4, 36) is connected or connectable to the coupling socket (3) via the screw-on part (9).

18. The coupling (1′) as claimed in claim 1, wherein the drive element (48) has a first, annular outer connecting part (49) and a second, annular inner connecting part (50) which are arranged concentrically and together form the first engagement structure and are connected by a radially extending first groove membrane disk (51), and the first groove membrane disk (51) is fixed in an integrally bonded manner to the two connecting parts (49, 50).

19. The coupling (1′) as claimed in claim 18, wherein the coupling socket (3) has first connecting structures (52) on the second outer pipeline element (24) and second connecting structures (53) on the second inner pipeline element (23), that together form the second engagement structure.

20. The coupling (1′) as claimed in claim 18, wherein the first engagement structure and the second engagement structure interact as a bayonet lock.

21. The coupling (1′) as claimed in claim 18, wherein the coupling socket (3) has a radially extending second grooved membrane disk (54) which connects the second outer pipeline element (24) and the second inner pipeline element (23) and which is arranged in a form-fit with the first grooved membrane disk (51).

22. The coupling (1′) as claimed in claim 21, wherein the second grooved membrane disk (54) is axially supported at a rear thereof.

23. The coupling (1′) as claimed in claim 21, wherein the first grooved membrane disk (51) and the second grooved membrane disk (54) have different dimensions in a radial direction.

24. The coupling (1′) as claimed in claim 21, wherein the coupling plug (2) has a radially extending third grooved membrane disk (59) which connects the first outer pipeline element (14) and the first inner pipeline element (13) and which is arranged in a form-fit with respect to the first grooved membrane disk (51) and the second grooved membrane disk (54).

25. The coupling (1′) as claimed in claim 24, wherein the third grooved membrane disk (59) is axially supported at a rear thereof.

26. The coupling (1′) as claimed in claim 24, wherein the first grooved membrane disk (51) and the third grooved membrane disk (59) have a same dimension in a radial direction.
